(19) United States
(12) Patent Application Publication
(10) Pub. No.: US 2004/0260638 A1
(43) Pub. Date: Dec. 23, 2004

(54) System and method for electronic trading through product serial numbers

(76) Inventors: Shih-Li Wen, Taipei (TW); Yun-Yang Chang, Taipei (TW); Hsiang-Min Liu, Taipei (TW); Chie-Chien Chien, Taipei (TW); I-Ping Hu, Taipei (TW); Chiu-Yin Lin, Taipei (TW)

Correspondence Address: BIRCH STEWART KOLASCH & BIRCH, PO BOX 747, FALLS CHURCH, VA, 22040-0747, US

(21) Appl. No.: 10/462,281

(22) Filed: Jun. 17, 2003

(51) Int. Cl. G06F 17/60

(52) U.S. Cl. 705/37

(57) ABSTRACT

A system and method for performing electronic trading through serial numbers of merchandise is disclosed. The system includes at least a merchandise supplier end and a customer end. The merchandise supplier end prepares a merchandise database with merchandise and correspondent serial numbers. The customer end can order the merchandise by just inputting the serial number through an electronic device. Then, the device helps the customer end finishing the order to the supplier by just a keying of the customer end so as to prevent from conventional complicated process.

### BACKGROUND OF THE INVENTION

1. Field of the Invention

The invention generally relates to a system and method for electronic trading, and particularly relates to a system and method for electronic trading through serial numbers of merchandise.

2. Related Art

Commercial products are usually traded through some kinds of selling paths. Conventional selling tools are posters, catalogues, direct mails, broadcasting and so on. The selling tools persuade people coming to stores and purchasing. Now, as electronic trading and electronic devices are being developed, new kinds of selling paths and selling tools are also widely used. Customers can purchase merchandise through electronic trading with mobile phones, personal computers or the like. The trading can be operated by a virtual store without the need of space and facilities as that of a conventional store. Some costs can thus be reduced. The conventional selling tools can still be used for sales promotion. The trading operated through electronic manners and networks with electronic devices of customers and virtual stores of suppliers can shorten the merchandise chain and reduce some selling costs.

However, in the aforesaid electronic trading, besides using new trading paths linking directly through networks, the customers noticed by conventional selling tools have to find out the product network sites for sending their orders. Usually, the customers have to search the web sites for the suppliers, finding out the specific products, paying and acquiring the products from the suppliers by means of hardware mailing or software downloading. The customer may spend a lot of time and efforts for the searching that possibly frustrates the customer and hinders the trading.

Therefore, the invention intends to provide a system and method for performing electronic trading through serial numbers of merchandise. By using the serial number, the customer can order the merchandise by just inputting the serial number through an electronic device. Then, the device helps the customer finishing the order to the supplier by just a keying of the customer so as to prevent from conventional complicated process.

### SUMMARY OF THE INVENTION

The object of the invention is to provide a system and method for performing electronic trading through serial numbers of merchandise. The customer end can order the merchandise by just inputting the serial number through an electronic device. Then, the device helps the customer end finishing the order to the supplier by just a keying of the customer end so as to prevent from conventional complicated process.

A system for performing electronic trading through serial numbers of merchandise according to the invention generally includes a merchandise provider end, a telecommunication provider end or internet service provider end and a customer end. The merchandise supplier end is linked with the telecommunication provider end or the internet service provider end; and the telecommunication provider end or internet service provider end is linked with the customer end.

A merchandise database is prepared at the merchandise supplier site. The database includes merchandise information and correspondent serial numbers. Each merchandise serial number is composed of a code of the telecommunication provider end or internet service provider end, a classification code and a serial number of the product. The telecommunication provider end or internet service provider end verifies the identification of the customer end and provides a mechanism of payment and trading to the customer end and the merchandise Supplier end when the customer end orders merchandise from the merchandise supplier end through the telecommunication provider end or internet service provider end. The customer end only has to input the merchandise serial number of the specific product.

In operation, when the customer end is using an electronic device, such as a mobile phone or a computer, the process is as follows. The customer end first transfers his or her identification code to the telecommunication provider end or the internet service provider end. The telecommunication provider end or internet service provider end verifies the identification code and confirms with the customer end. Then, the customer end transfers merchandise serial number to the telecommunication provider end or the internet service provider end, and finishes payment. The telecommunication provider end or internet service provider end transfers the merchandise serial number to the merchandise supplier end. The merchandise supplier end verifies the specific merchandise according to the merchandise serial number and accomplishes the trading by sending the merchandise to the customer end if it is a hardware, or transferring through network to the customer end if it is a software. In an embodiment of the invention, the merchandise serial number is composed of a code of the telecommunication provider end or internet service provider end, a classification code and a serial number of the product.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a systematic block diagram of the invention;

FIG. 2 is a series of examples of merchandise serial numbers according to the invention;

FIG. 3 is a flowchart of an electronic trading system of the invention; and

FIG. 4 is another flowchart of an electronic trading system of the invention.

### DETAILED DESCRIPTION OF THE INVENTION

The invention provides a system and method for performing electronic trading through serial numbers of merchandise. The customer end can order the merchandise by just inputting the serial number through an electronic device. Then, the device helps the customer end finishing the order to the supplier by just a keying of the customer end so as to prevent from conventional complicated process.

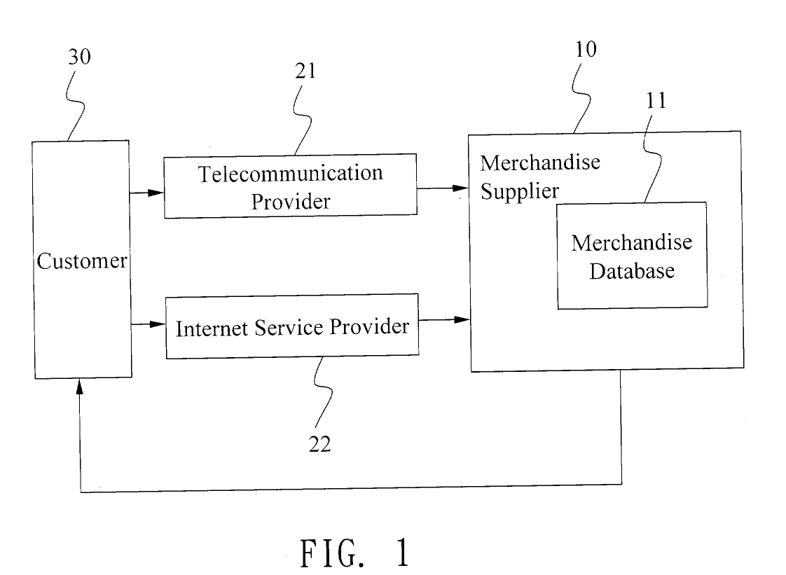

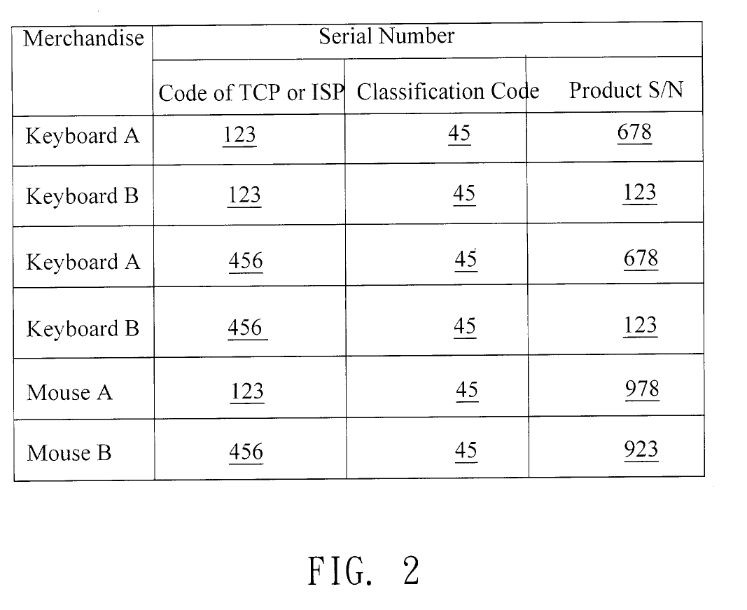

As shown in FIG. 1 and FIG. 2, a system for performing electronic trading through serial numbers of merchandise according to the invention includes at least a merchandise provider end 10, a telecommunication provider end 21 or internet service provider end 22 and a customer end 30. The merchandise supplier end 10 is linked with the telecommunication provider end 21 or internet service provider end 22. The telecommunication provider end 21 or internet service provider end 22 is linked with the customer end 30.

A merchandise database 11 is prepared at the site of the merchandise supplier end 10. The database 11 includes merchandise information and correspondent serial numbers. Each merchandise serial number 11 is composed of a code of the telecommunication provider end 21 or a code of the internet service provider end 22, a classification code and a serial number of the product. For example, supposing a code of a telecommunication provider end or internet service provider end is “123”; a code of another telecommunication provider end or internet service provider end is “456”. A code for computer peripherals, including keyboard A, keyboard B, mouse A and mouse B, etc. is “45”. The rest are the respective serial numbers of each product, e.g., “678” of keyboard A, “123” of keyboard B, “978” of mouse A and “923” of mouse B.

The telecommunication provider end 21 or internet service provider end 22 verifies the identification of the customer end 30 and provides a mechanism of payment and trading to the customer end 30 and the merchandise supplier end 10 when the customer end 30 orders merchandise from the merchandise supplier end 10 through the telecommunication provider end 21 or internet service provider end 22. The customer end 30 only has to input the merchandise serial number of the specific product that is registered in the merchandise database 11.

In operation, when the customer end 30 is using a mobile phone as a device to link to a telecommunication provider end 21, the process is as follows. The customer end 30 first transfers his or her identification code to the telecommunication provider end 21. The telecommunication provider end 21 verifies the identification code and confirms with the customer end 30. Then, the customer end 30 transfers a merchandise serial number to the telecommunication provider end 21, and finishes payment. The telecommunication provider end 21 transfers the merchandise serial number to the merchandise supplier end 10. The merchandise supplier end 10 verifies the specific merchandise according to the merchandise serial number and accomplishes the trading by sending the merchandise to the customer end if it is a hardware, or transferring through network to the customer end if it is a software. In an embodiment of the invention, the merchandise serial number is composed of a code of the telecommunication provider end 21 (e.g., a code “123” of one provider and a code “456” of another), a classification code (e.g., “45” for computer peripherals including keyboard and mouse) and a serial number of the product (e.g., “678” of keyboard A, “123” of keyboard B, “978” of mouse A and “923” of mouse B).

Similarly, when the customer end 30 is using a computer as a device to link to an internet service provider end 22, the process is as follows. The customer end 30 first transfers his or her identification code to the internet service provider end 22. The internet service provider end 22 verifies the identification code and confirms with the customer end 30. Then, the customer end 30 transfers a merchandise serial number to the internet service provider end 22, and finishes payment. The internet service provider end 22 transfers the merchandise serial number to the merchandise supplier end 10. The merchandise supplier end 10 verifies the specific merchandise according to the merchandise serial number and accomplishes the trading by sending the merchandise to the customer end if it is a hardware, or transferring through network to the customer end if it is a software. In an embodiment of the invention, the merchandise serial number is composed of a code of the internet service provider end 22 (e.g., a code “123” of one provider and a code “456” of another), a classification code (e.g., “45” for computer peripherals including keyboard and mouse) and a serial number of the product (e.g., “678” of keyboard A, “123” of keyboard B, “978” of mouse A and “923” of mouse B).

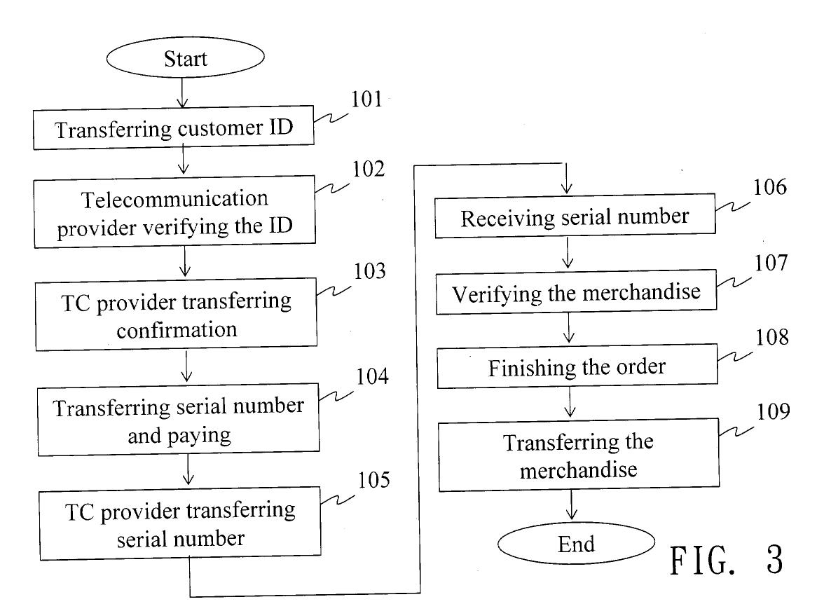

As shown in FIG. 2 and FIG. 3, when a customer end is using a mobile phone as a device to link to a telecommunication provider end, the method for performing electronic trading according to the invention includes the following steps.

First, the customer end transferring an identification code (step 101);

The telecommunication provider end verifying and confirming the identification code (step 102);

The customer end transferring the merchandise serial number and finishing payment through the telecommunication provider end (step 104); The merchandise serial number is composed of a code of the internet service provider end 22 (e.g., a code “123” of one provider and a code “456” of another), a classification code (e.g., “45” for computer peripherals including keyboard and mouse) and a serial number of the product (e.g., “678” of keyboard A, “123” of keyboard B, “978” of mouse A and “923” of mouse B);

The telecommunication provider end transferring the merchandise serial number to the merchandise supplier end after verifying the payment of the customer end (step 105);

The merchandise supplier end receiving the merchandise serial number (step 106);

The merchandise supplier end verifying the merchandise according to the merchandise serial number and the merchandise database (step 107);

The merchandise supplier end finishing the trade (step 108); and

Finally, the merchandise supplier end transferring the merchandise to the customer end by sending a hardware product to the customer end or transferring a software product to the customer end (step 109).

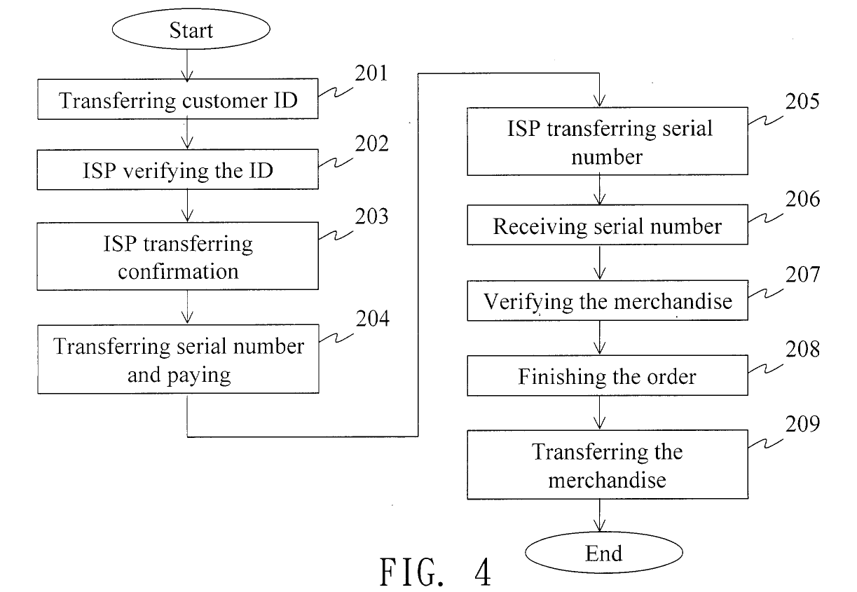

As shown in FIG. 2 and FIG. 4, when a customer end is using a computer as a device to link to an internet service provider end, the method for performing electronic trade according to the invention includes the following steps.

First, the customer end transferring an identification code (step 201);

The internet service provider end verifying and confirming the identification code (step 202);

The customer end transferring the merchandise serial number and finishing payment through the internet service provider end (step 204); The merchandise serial number is composed of a code of internet service provider end 22 (e.g., a code “123” of one provider and a code “456” of another), a classification code (e.g., “45” for computer peripherals including keyboard and mouse) and a serial number of the product (e.g., “678” of keyboard A, “123” of keyboard B, “978” of mouse A and “923” of mouse B);

The internet service provider end transferring the merchandise serial number to the merchandise supplier end after verifying the payment of the customer end (step 205);

The merchandise supplier end receiving the merchandise serial number (step 206);

The merchandise supplier end verifying the merchandise according to the merchandise serial number and the merchandise database (step 207);

The merchandise supplier end finishing the trade (step 208); and

Finally, the merchandise supplier end transferring the merchandise to the customer end by sending a hardware product to the customer end or transferring a software product to the customer end (step 209).

In conclusion, a system and method for performing electronic trade according to the invention utilizes merchandise serial numbers. The customer end can order the merchandise by just inputting the serial number through an electronic device. Then, the device helps the customer end finishing the order to the merchandise supplier end by just a keying of the customer end so as to prevent from conventional complicated process.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for performing electronic trading based on merchandise serial number, comprising:
a merchandise supplier end, having a merchandise database comprising at least a kind of merchandise and at least a serial number correspondent to said merchandise; and
a customer end, capable of transferring a merchandise serial number to said merchandise supplier end so as to be verified by said database and finished with trading of said correspondent merchandise.

2. A system for performing electronic trading based on merchandise serial number according to claim 1 wherein said merchandise is a software product to be transferred from said merchandise supplier end to said customer end.

3. A system for performing electronic trading based on merchandise serial number according to claim 1 wherein said merchandise is a hardware product to be sent from said merchandise supplier end to said customer end.

4. A system for performing electronic trading based on merchandise serial number according to claim 1 further comprises a telecommunication supplier for said customer end to link with an electronic device via said telecommunication supplier to said merchandise supplier end; said telecommunication supplier verifies an identification code and payment of said customer end, and transfers said merchandise serial number to said merchandise supplier end.

5. A system for performing electronic trading based on merchandise serial number according to claim 4 wherein said merchandise serial number is composed of a code of said telecommunication supplier, a classification code and a serial number of product.

6. A system for performing electronic trading based on merchandise serial number according to claim 4 wherein said customer end first transfers an identification code to said telecommunication supplier; said telecommunication supplier verifies said identification code and confirms with said customer end.

7. A system for performing electronic trading based on merchandise serial number according to claim 1 further comprises an internet service supplier for said customer end to link with an electronic device via said internet service supplier to said merchandise supplier end; said internet service supplier verifies an identification code and payment of said customer end, and transfers said merchandise serial number to said merchandise supplier end.

8. A system for performing electronic trading based on merchandise serial number according to claim 7 wherein said merchandise serial number is composed of a code of said internet service supplier, a classification code and a serial number of product.

9. A system for performing electronic trading based on merchandise serial number according to claim 7 wherein said customer first transfers an identification code to said internet service supplier; said internet service supplier verifies said identification code and confirms with said customer.

10. A method for performing electronic trading, based on merchandise serial number, comprising steps of:
transferring by a customer a merchandise serial number correspondent to a product;
receiving by a merchandise supplier said merchandise serial number;
verifying a product with said merchandise serial number by said merchandise supplier with a merchandise database; and
finishing said trading.

11. A method for performing electronic trading based on merchandise serial number according to claim 10 wherein said product is a software product to be transferred form said merchandise supplier end to said customer end.

12. A system for performing electronic trading based on merchandise serial number according to claim 10 wherein said product is a hardware product to be sent form said merchandise supplier end to said customer end.

13. A method for performing electronic trading based on merchandise serial number according to claim 10, before said step of transferring by a customer end a merchandise serial number correspondent to a product, further comprising steps of:
transferring an identification code by said customer end to a telecommunication supplier;
verifying said identification code by said telecommunication supplier; and
confirming said identification code by said telecommunication supplier to said customer end.

14. A method for performing electronic trading based on merchandise serial number according to claim 13 further comprises a step of finishing payment by said customer end to said telecommunication supplier.

15. A method for performing electronic trading based on merchandise serial number according to claim 14, after said step of transferring by a customer end a merchandise serial number correspondent to a product, further comprises steps of verifying said payment of said customer end by said telecommunication supplier and transferring said merchandise serial number to said merchandise supplier end.

16. A method for performing electronic trading based on merchandise serial number according to claim 15 wherein said merchandise serial number is composed of a code of said telecommunication supplier, a classification code and a serial number of product.

17. A method for performing electronic trading based on merchandise serial number according to claim 10, before said step of transferring by a customer end a merchandise serial number correspondent to a product, further comprising steps of:
transferring an identification code by said customer end to an internet service supplier;
verifying said identification code by said internet service supplier; and
confirming said identification code by said internet service supplier to said customer end.

18. A method for performing electronic trading based on merchandise serial number according to claim 17 further comprises a step of finishing payment by said customer end to said internet service supplier.

19. A method for performing electronic trading based on merchandise serial number according to claim 18, after the step of transferring by a customer end a merchandise serial number correspondent to a product, further comprises steps of verifying said payment of said customer end by said internet service supplier and transferring said merchandise serial number to said merchandise supplier end.

20. A method for performing electronic trading based on merchandise serial number according to claim 19 wherein said merchandise serial number is composed of a code of said internet service supplier, a classification code and a serial number of product.
